(19) United States
(12) Patent Application Publication
(10) Pub. No.: US 2013/0089270 A1
(43) Pub. Date: Apr. 11, 2013

(54) IMAGE PROCESSING APPARATUS

(71) Applicant: Sanyo Electric Co., Ltd., Osaka (JP)

(72) Inventor: Wataru Takayanagi, Osaka (JP)

(73) Assignee: SANYO ELECTRIC CO., LTD., Osaka (JP)

(21) Appl. No.: 13/633,321

(22) Filed: Oct. 2, 2012

(30) Foreign Application Priority Data
Oct. 6, 2011 (JP) 2011-222271

(51) Int. Cl. G06K 9/40

(52) U.S. Cl. 382/274

(57) ABSTRACT

An image processing apparatus includes an acquirer. An acquirer acquires a plurality of images, respectively corresponding to a plurality of exposure amounts different from one another, and each of which represents a common scene. A calculator calculates a composite coefficient with reference to at least a part of luminance characteristics of the plurality of images acquired by the acquirer 1. A first composer composes the plurality of images acquired by the acquirer with reference to the composite coefficient calculated by the calculator. A corrector corrects a value of the composite coefficient calculated by the calculator with reference to a luminance characteristic of a composed image created by the first composer. A second composer composes the plurality of images acquired by the acquirer with reference to a composite coefficient having the value corrected by the corrector.

### CROSS REFERENCE OF RELATED APPLICATION

The disclosure of Japanese Patent Application No. 2011-222271, which was filed on Oct. 6, 2011, is incorporated herein by reference.

### BACKGROUND OF THE INVENTION

1. Field of the Invention

The present invention relates to an image processing apparatus, and in particular, relates to an image processing apparatus which creates a composed image, based on a plurality of images, respectively corresponding to a plurality of exposure settings different from one another, and each of which represents a common scene.

2. Description of the Related Art

According to one example of this type of apparatus, a standard image is photographed by an appropriate exposure, and a histogram of the photographed standard image is acquired by a histogram process portion. A dynamic range expansion determining portion determines necessity of a dynamic range expansion based on the acquired histogram, and when the expansion is needed, a photographing parameter for a different exposure is decided by a parameter determination portion. An imaging element control portion performs a second photographing based on the decided photographing parameter so as to acquire a non-standard image. A wide dynamic range image is created by composing the standard image and the non-standard image thus acquired. It is noted that, when the expansion is not needed, the second photographing is stopped, and only the standard image is outputted.

However, in the above-described apparatus, a histogram of the standard image and/or the non-standard image is not referred to upon composing the standard image and the non-standard image, and therefore, an image composing performance is limited.

### SUMMARY OF THE INVENTION

An image processing apparatus according to the present invention, comprises: an acquirer which acquires a plurality of images, respectively corresponding to a plurality of exposure amounts different from one another, and each of which represents a common scene; a calculator which calculates a composite coefficient with reference to at least a part of luminance characteristics of the plurality of images acquired by the acquirer; a first composer which composes the plurality of images acquired by the acquirer with reference to the composite coefficient calculated by the calculator; a corrector which corrects a value of the composite coefficient calculated by the calculator with reference to a luminance characteristic of a composed image created by the first composer; and a second composer which composes the plurality of images acquired by the acquirer with reference to a composite coefficient having the value corrected by the corrector.

According to the present invention, an image composing program recorded on a non-transitory recording medium in order to control an image processing apparatus, the program causing a processor of the image processing apparatus to perform the steps, comprises: an acquiring step of acquiring a plurality of images, respectively corresponding to a plurality of exposure amounts different from one another, and each of which represents a common scene; a calculating step of calculating a composite coefficient with reference to at least a part of luminance characteristics of the plurality of images acquired by the acquiring step; a first composing step of composing the plurality of images acquired by the acquiring step with reference to the composite coefficient calculated by the calculating step; a correcting step of correcting a value of the composite coefficient calculated by the calculating step with reference to a luminance characteristic of a composed image created by the first composing step; and a second composing step of composing the plurality of images acquired by the acquiring step with reference to a composite coefficient having the value corrected by the correcting step.

According to the present invention, an image composing method executed by an image processing apparatus, comprises: an acquiring step of acquiring a plurality of images, respectively corresponding to a plurality of exposure amounts different from one another, and each of which represents a common scene; a calculating step of calculating a composite coefficient with reference to at least a part of luminance characteristics of the plurality of images acquired by the acquiring step; a first composing step of composing the plurality of images acquired by the acquiring step with reference to the composite coefficient calculated by the calculating step; a correcting step of correcting a value of the composite coefficient calculated by the calculating step with reference to a luminance characteristic of a composed image created by the first composing step; and a second composing step of composing the plurality of images acquired by the acquiring step with reference to a composite coefficient having the value corrected by the correcting step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an assignment state of an evaluation area in an imaging surface;

FIG. 5 (A) is a graph showing one example of a histogram of image data acquired by a normal exposure;

FIG. 5 (B) is a graph showing one example of a histogram of image data acquired by a long exposure;

FIG. 5 (C) is a graph showing one example of a histogram of image data acquired by a short exposure;

FIG. 6 (A) is a graph showing one example of a histogram of reduced image data acquired by the normal exposure;

FIG. 6 (B) is a graph showing one example of a state where a histogram of reduced image data acquired by the long exposure is shifted to a low luminance side with reference to a shift amount SFT_S;

FIG. 6 (C) is a graph showing one example of a state where a histogram of reduced image data acquired by the short exposure is extended to a high luminance side with reference to a gain GN_S;

FIG. 7 (A) is a graph showing one example of a histogram of composite reduced image data that is based on the reduced image data shown in FIG. 6 (A) to FIG. 6 (C);

FIG. 7 (B) is a graph showing one example of a state where a histogram of the composite reduced image data is shifted to the low luminance side with reference to a shift amount SFT_L;

FIG. 7 (C) is a graph showing one example of a state where the shifted histogram of the composite reduced image data is extended to the high luminance side;

FIG. 8 (A) is a graph showing one example of the histogram of the image data acquired by the normal exposure;

FIG. 8 (B) is a graph showing one example of a state where the histogram of the image data acquired by the long exposure is shifted to the low luminance side with reference to a shift amount SFT_C;

FIG. 8 (C) is a graph showing one example of a state where the histogram of the image data acquired by the short exposure is extended to the high luminance side with reference to a gain GN_C;

FIG. 9 is a graph showing one example of a histogram of composite reduced image data that is based on the image data shown in FIG. 8 (A) to FIG. 8 (C);

FIG. 10 is a flowchart showing one portion of behavior of a CPU applied to the embodiment in FIG. 2;

FIG. 11 is a flowchart showing another portion of behavior of the CPU applied to the embodiment in FIG. 2;

FIG. 12 is a flowchart showing still another portion of behavior of the CPU applied to the embodiment in FIG. 2;

FIG. 13 is a flowchart showing yet another portion of behavior of the CPU applied to the embodiment in FIG. 2; and

FIG. 14 is a block diagram showing a configuration of another embodiment of the present invention.

### DETAILED DESCRIPTION OF THE PREFERRED EMBODIMENTS

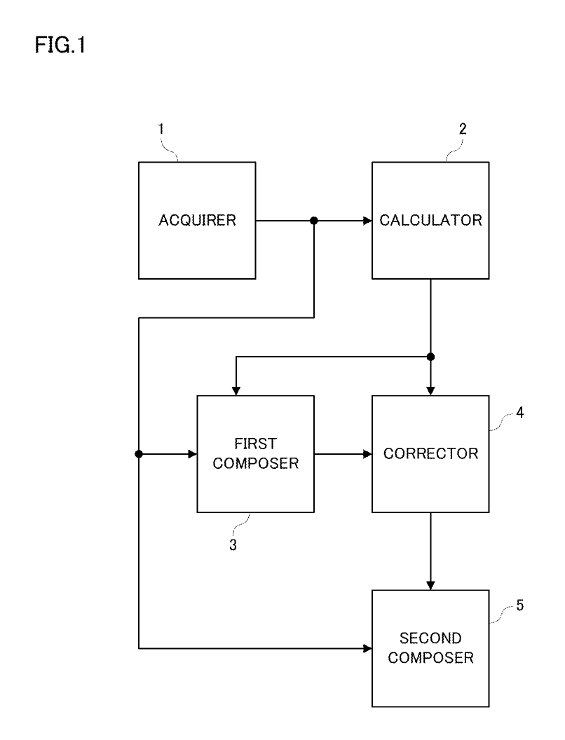

With reference to FIG. 1, an image processing apparatus according to one embodiment of the present invention is basically configured as follows: An acquirer 1 acquires a plurality of images, respectively corresponding to a plurality of exposure amounts different from one another, and each of which represents a common scene. A calculator 2 calculates a composite coefficient with reference to at least a part of luminance characteristics of the plurality of images acquired by the acquirer 1. A first composer 3 composes the plurality of images acquired by the acquirer 1 with reference to the composite coefficient calculated by the calculator 2. A corrector 4 corrects a value of the composite coefficient calculated by the calculator 2 with reference to a luminance characteristic of a composed image created by the first composer 3. A second composer 5 composes the plurality of images acquired by the acquirer 1 with reference to a composite coefficient having the value corrected by the corrector 4.

Thus, the composite coefficient is calculated based on the acquired plurality of images, and is corrected based on the composed image created with reference to the composite coefficient. A composing process for the acquired plurality of images is executed again with reference to the corrected composed image. Thereby, an image composing performance is improved.

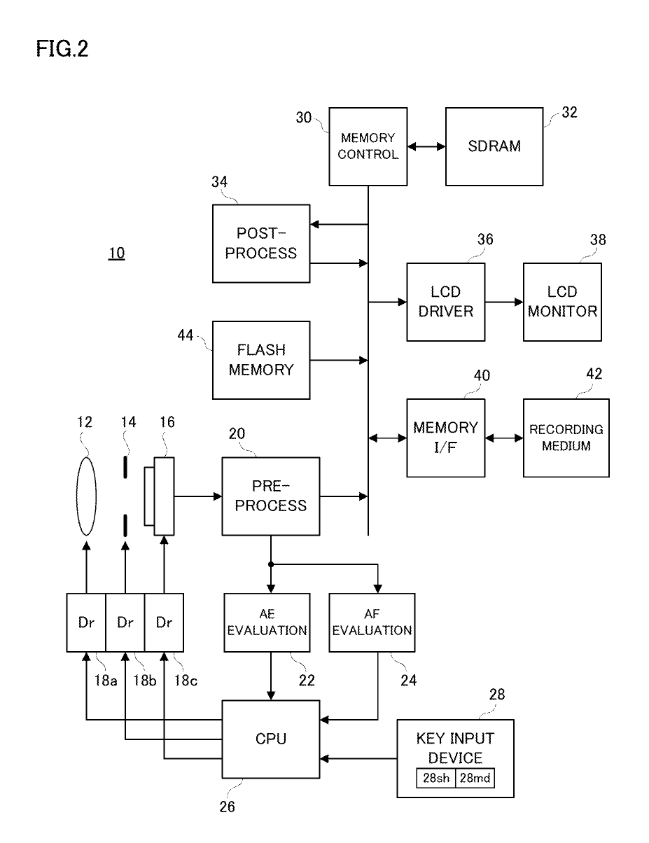

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an imager 16, and is subjected to a photoelectric conversion. Thereby, electric charges corresponding to the optical image are produced.

When a power source is applied, in order to execute a moving-image taking process, a CPU 26 commands a driver 18c to repeat an exposure procedure and an electric-charge reading-out procedure under an imaging task. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data that is based on the read-out electric charges is cyclically outputted.

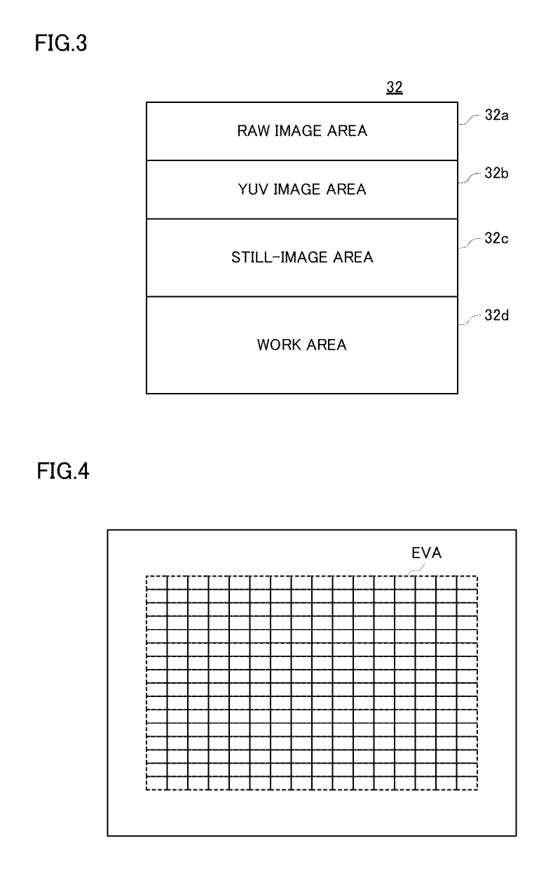

A pre-processing circuit 20 performs processes, such as digital clamp, pixel defect correction, gain control and etc., on the raw image data outputted from the imager 16. The raw image data on which these processes are performed is written into a raw image area 32a of an SDRAM 32 through a memory control circuit 30 (see FIG. 3).

A post-processing circuit 34 reads out the raw image data stored in the raw image area 32a through the memory control circuit 30, and performs a color separation process, a white balance adjusting process and a YUV converting process, on the read-out raw image data. The YUV formatted image data produced thereby is written into a YUV image area 32b of the SDRAM 32 by the memory control circuit 30 (see FIG. 3).

An LCD driver 36 repeatedly reads out the image data stored in the YUV image area 32b through the memory control circuit 30, and drives an LCD monitor 38 based on the read-out image data. As a result, a real-time moving image (a live view image) representing the scene captured on the imaging surface is displayed on a monitor screen.

With reference to FIG. 4, an evaluation area EVA is assigned to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, at every time the vertical synchronization signal Vsync is generated. Thereby, 256 integral values (256 AE evaluation values) are outputted from the AE evaluating circuit 22 in response to the vertical synchronization signal Vsync. An AF evaluating circuit 24 integrates a high-frequency component of the RGB data belonging to the evaluation area EVA, out of the RGB data generated by the pre-processing circuit 20, at every time the vertical synchronization signal Vsync is generated. Thereby, 256 integral values (256 AF evaluation values) are outputted from the AF evaluating circuit 24 in response to the vertical synchronization signal Vsync.

When a shutter button 28sh arranged in a key input device 28 is in a non-operated state, the CPU 26 executes a simple AE process based on the 256 AE evaluation values outputted from the AE evaluating circuit 22 so as to calculate an appropriate EV value. An aperture amount and an exposure time period that define the calculated appropriate EV value are set to the drivers 18b and 18c, respectively, and thereby, a brightness of a live view image is adjusted roughly.

When the shutter button 28sh is half-depressed, the CPU 26 executes a strict AE process referring to the AE evaluation values so as to calculate an optimal EV value. An aperture amount and an exposure time period that define the calculated optimal EV value are also set to the drivers 18b and 18c, respectively, and thereby, a brightness of a live view image is adjusted strictly. Moreover, the CPU 26 executes an AF process based on the 256 AF evaluation values outputted from the AF evaluating circuit 24. In order to search for a focal point, the focus lens 12 is moved by the driver 18a in an optical-axis direction, and is placed at the focal point discovered thereby. As a result, a sharpness of a live view image is improved.

An imaging mode is switched by a mode selector switch 28md between a normal mode and an HDR (High Dynamic Range) mode.

When the shutter button 28sh is fully depressed in a state where the normal mode is selected, the CPU 26 executes a still-image taking process only once. As a result, one frame of image data representing a scene at a time point at which the shutter button 28sh is fully depressed is evacuated from a YUV image area 32b to a still-image area 32c (see FIG. 3).

When the shutter button 28sh is fully depressed in a state where the HDR mode is selected, the CPU 26 takes three frames of image data respectively corresponding to three exposure amounts different from one another into the still-image area 32c, and creates one frame of composite image data based on the taken three frames of image data (a detail will be described later). The composite image data is created in a work area 32d (see FIG. 3), and is returned to the still-image area 32c thereafter.

When one frame of still-image data or composite image data is thus acquired, the CPU 26 applies a corresponding command to a memory I/F 40 in order to execute a recording process. The memory I/F 40 reads out the one frame of the image data stored in the still-image area 32c through the memory control circuit 30 so as to record the read-out image data on a recording medium 42 in a file format.

In the HDR process, firstly, YUV-formatted image data (image data of the first frame) that is based on raw image data outputted from the imager 16 after the shutter button 28sh being fully depressed is evacuated from the YUV image area 32b to the still-image area 32c.

Subsequently, an exposure setting (=an aperture amount and/or an exposure time period) is changed so that an exposure amount of the imaging surface indicates a times an exposure amount equivalent to the optimal EV value, and YUV-formatted image data (image data of the second frame) that is based on raw image data outputted from the imager 16 after changing is evacuated from the YUV image area 32b to the still-image area 32c.

Subsequently, the exposure setting (=the aperture amount and/or the exposure time period) is changed so that the exposure amount of the imaging surface indicates 1/α times the exposure amount equivalent to the optimal EV value, and YUV-formatted image data (=image data of the third frame) that is based on raw image data outputted from the imager 16 after changing is evacuated from the YUV image area 32b to the still-image area 32c.

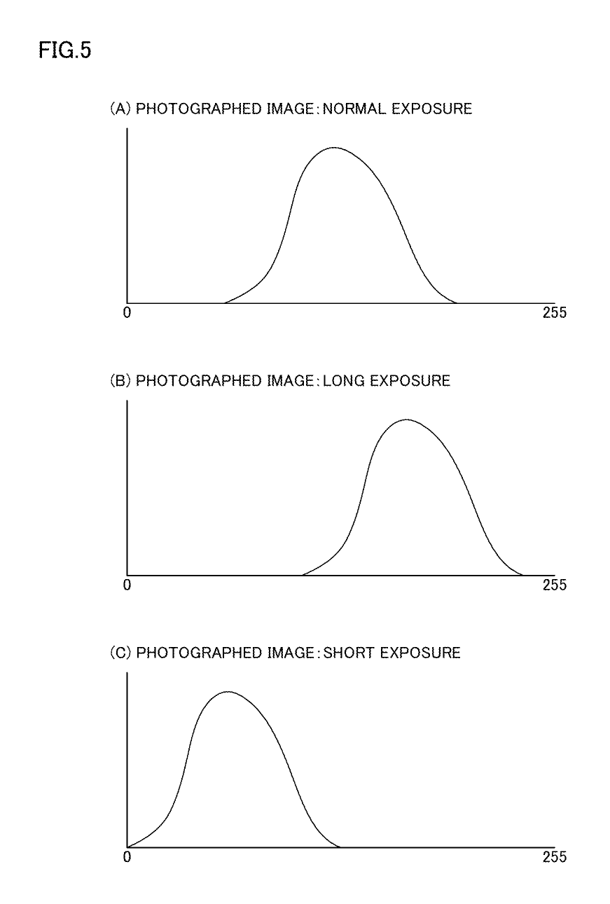

The three frames of image data thus acquired represent common scenes, and indicate histograms shown in FIG. 5 (A) to FIG. 5 (C), for example. The histogram shown in FIG. 5 (A) indicates a luminance distribution of the image data of the first frame, the histogram shown in FIG. 5 (B) indicates a luminance distribution of the image data of the second frame and the histogram shown in FIG. 5 (C) indicates a luminance distribution of the image data of the third frame.

When the three frames of the image data are secured in the still-image area 32c, a positional deviation between an image represented by the image data of the first frame and an image represented by the image data of the second frame is detected as an offset OFST12, and a positional deviation between the image represented by the image data of the first frame and an image represented by the image data of the third frame is detected as an offset OFST13.

Subsequently, the image data of the first frame to the third frame evacuated to the still-image area 32c are duplicated on the work area 32d and are individually reduced. Thereby, reduced image data of the first frame to the third frame are acquired on the work area 32d.

When the three frames of the reduced image data are created, a histogram of the reduced image data of the second frame is detected so as to calculate a shift amount SFT_S based on the detected histogram. The calculated shift amount SFT_S is equivalent to a coefficient for inhibiting a positional deviation of a histogram between the reduced image data of the first frame and the reduced image data of the second frame.

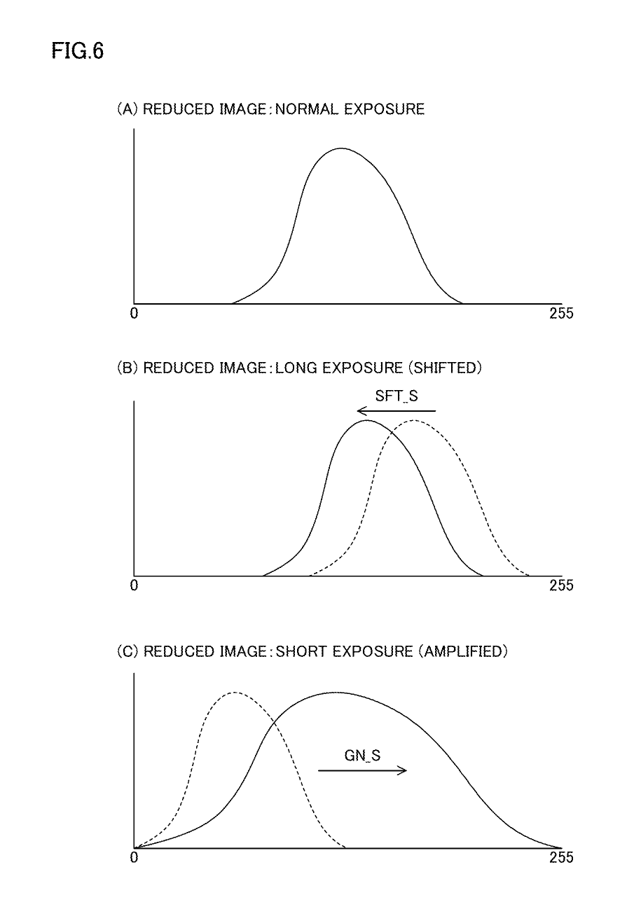

When the histogram of the reduced image data of the first frame has a characteristic shown in FIG. 6 (A) and the histogram of the reduced image data of the second frame has a characteristic indicated by a dot line shown in FIG. 6 (B), the histogram of the reduced image data of the second frame shifted to the low luminance side with reference to the shift amount SFT_S will have a characteristic indicated by a solid line shown in FIG. 6 (B).

The reduced image data of the first frame and the reduced image data of the second frame are composed with reference to the offset OFST12 and the shift amount SFT_S calculated in a manner described above. Firstly, a luminance of the reduced image data of the second frame is adjusted so that the histogram of the reduced image data of the second frame is shifted to the low luminance side by the shift amount SFT_S. Subsequently, with reference to the offset OFST12, the reduced image data having the adjusted luminance is composed with the reduced image data of the first frame. Thereby, intermediate-composite reduced image data in which blocked-up shadows are improved is acquired on the work area 32d.

When the intermediate-composite reduced image data is created, a histogram of the reduced image data of the third frame is detected so as to calculate a gain GN_S based on the detected histogram. The calculated gain GN_S is equivalent to a coefficient for extending the histogram of the reduced image data of the third frame to the high luminance side.

When the histogram of the reduced image data of the first frame has the characteristic shown in FIG. 6 (A) and the histogram of the reduced image data of the third frame has a characteristic indicated by a dot line shown in FIG. 6 (C), the histogram of the reduced image data of the third frame extended to the high luminance side with reference to the gain GN_S will have a characteristic indicated by a solid line shown in FIG. 6 (C).

The intermediate composite reduced image data and the reduced image data of the third frame are composed with reference to the offset OFST13 and the gain GN_S calculated in a manner described above. Firstly, a luminance of the reduced image data of the third frame is amplified according to the gain GN_S. Subsequently, with reference to the offset OFST13, reduced image data having the amplified luminance is composed with the intermediate composite reduced image data. Thereby, final composite reduced image data in which both of the blocked-up shadows and blown-out highlights are improved is acquired on the work area 32d.

Subsequently, a histogram of the final composite reduced image data is detected so as to calculate a shift amount SFT_L and a gain GN_L based on the detected histogram. The shift amount SFT_L is equivalent to a coefficient for shifting the histogram of the final composite reduced image data to the low luminance side. Moreover, the gain GN_L is equivalent to a coefficient for extending the histogram of the final composite reduced image data to the high luminance side.

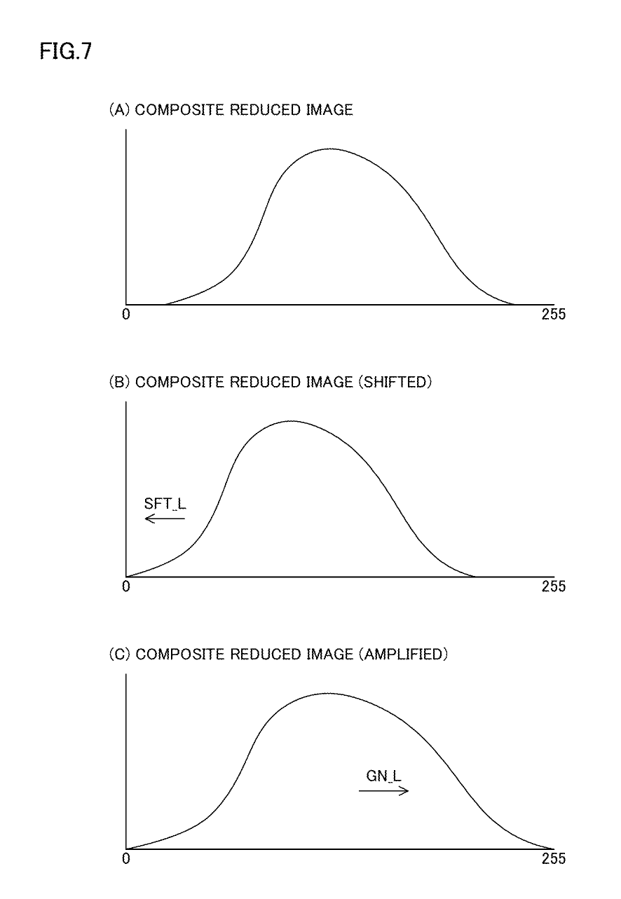

When the histogram of the final composite reduced image data has a characteristic shown in FIG. 7A), a magnitude of the shift amount SFT_L is equivalent to a magnitude in which a low-luminance edge of the histogram borders a lower limit of a depiction range (see FIG. 7 (B)). Moreover, the magnitude of the shift amount SFT_L is equivalent to a magnitude in which the histogram shifted to the low luminance side with reference to the shift amount SFT_L is extended to an upper limit of the depiction range (see FIG. 7 (C)).

The shift amount SFT_L is added to the above-described shift amount SFT_S, and thereby, a corrected shift amount SFT_C is obtained. Moreover, the gain GN_L is multiplied by the above-described gain GN_S, and thereby, a corrected gain GN_C is obtained.

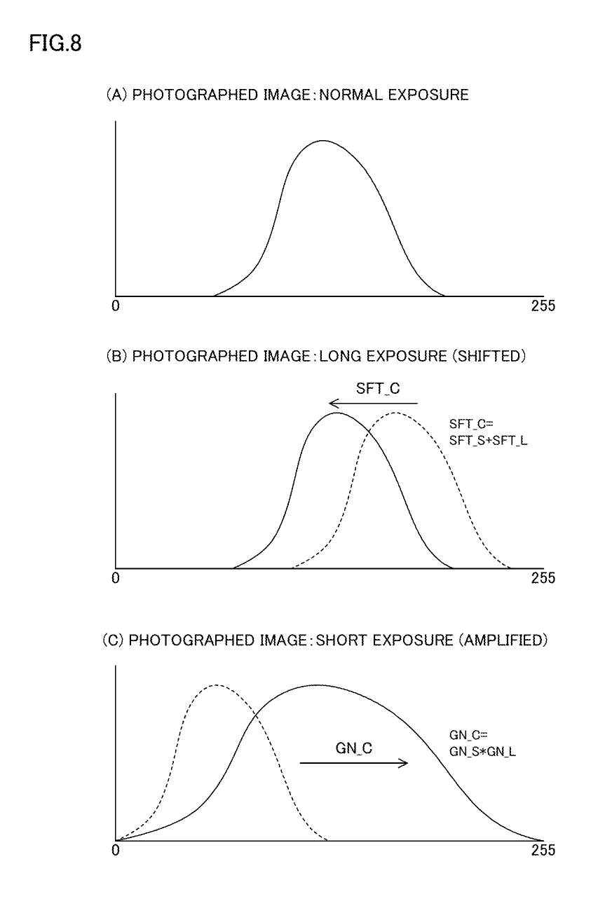

When the histogram of the image data of the first frame has a characteristic shown in FIG. 8 (A), the histogram of the image data of the second frame has a characteristic indicated by a dot line shown in FIG. 8 (B) and the histogram of the image data of the third frame has a characteristic indicated by a dot line shown in FIG. 8 (C), the histogram of the image data of the second frame shifted to the low luminance side with reference to the corrected shift amount SFT_C will have a characteristic indicated by a solid line shown in FIG. 8 (B) and the histogram of the image data of the third frame extended to the high luminance side with reference to the gain GN_S will have a characteristic indicated by a solid line shown in FIG. 8 (C).

When the corrected shift amount SFT_C and the corrected gain GN_C are thus calculated, the image data of the first frame to the second frame evacuated to the still-image area 32c are duplicated on the work area 32d, and the composing process is executed on the duplicated two frames of the image data. Firstly, a luminance of the image data of the second frame is adjusted so that the histogram of the image data of the second frame is shifted to the low luminance side by the corrected shift amount SFT_C. Subsequently, with reference to the offset OFST12, the image data having the adjusted luminance is composed with the image data of the first frame. Thereby, intermediate-composite image data in which the blocked-up shadows are further improved is acquired on the work area 32d.

Subsequently, the image data of the third frame evacuated to the still-image area 32c is duplicated on the work area 32d, and the composing process is executed on the intermediate-composite image data and the duplicated image data of the third frame. Firstly, a luminance of the image data of the third frame is amplified according to the gain GN_C. Subsequently, with reference to the offset OFST13, image data having the amplified luminance is composed with the intermediate composite image data. Thereby, final composite image data in which both of the blocked-up shadows and blown-out highlights are further improved is acquired on the work area 32d.

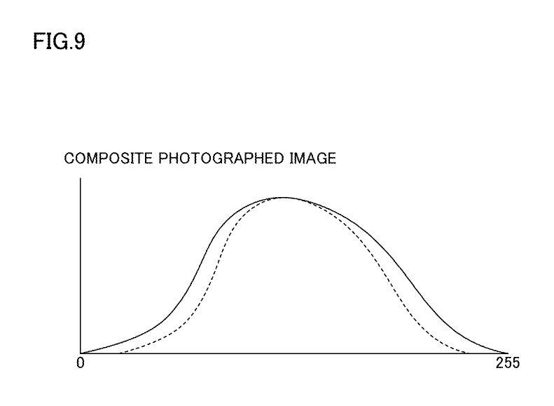

A histogram of the final composite image data has a characteristic indicated by a solid line shown in FIG. 9. For reference, a histogram of the final composite image data created with reference to the shift amount SFT_S and the gain GN_S has a characteristic indicated by a dot line shown in FIG. 9. Thereafter, the final composite image data is duplicated from the work area 32d to the still-image area 32c. The HDR process is ended after the duplication.

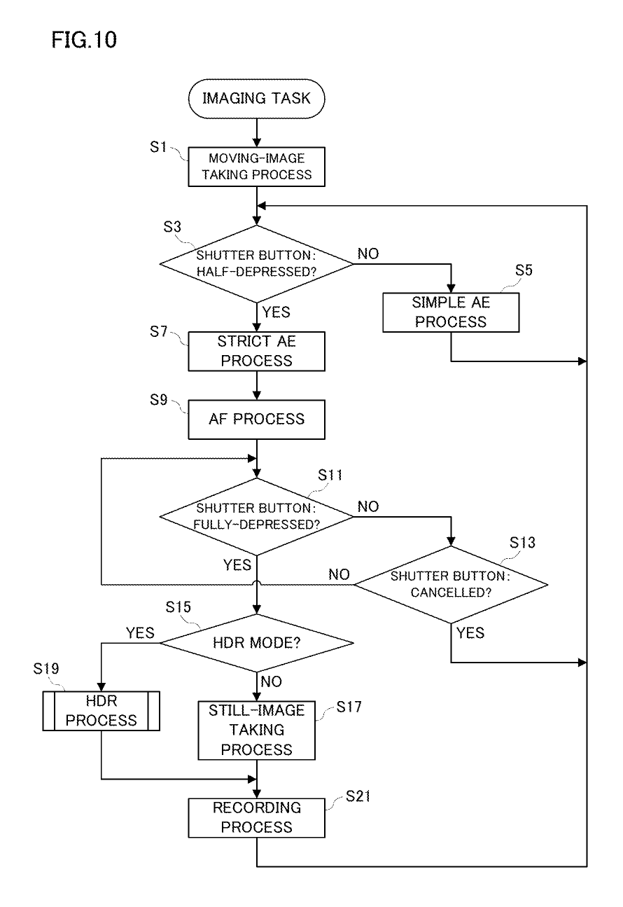

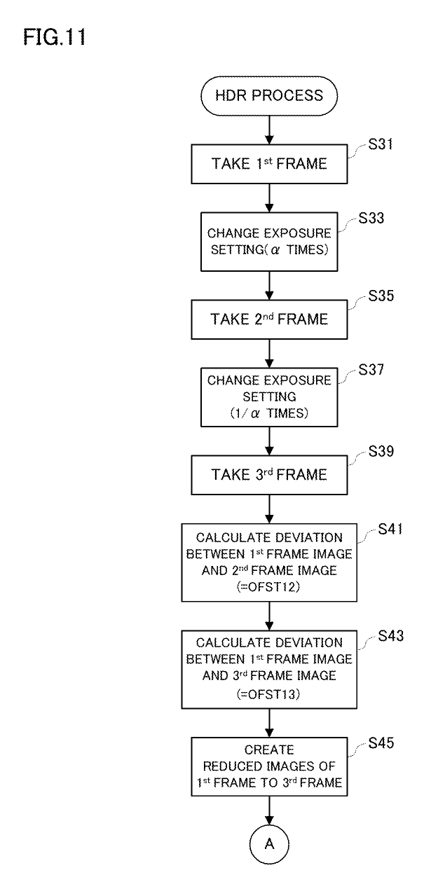

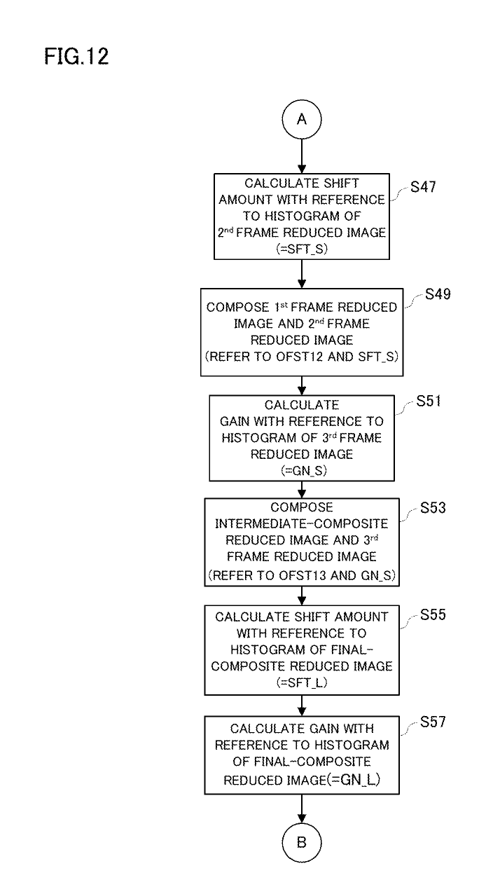

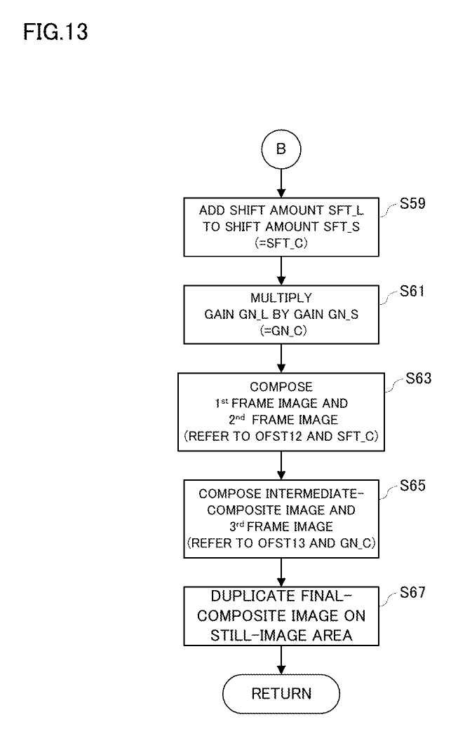

The CPU 26 executes, under the multi task operating system, a plurality of tasks including the imaging task shown in FIG. 10 to FIG. 13, in a parallel manner. It is noted that control programs corresponding to these tasks are stored in a flash memory 44.

With reference to FIG. 10, in a step S1, the moving-image taking process is executed. As a result, a live view image representing a scene captured on the imaging surface is displayed on the LCD monitor 38. In a step S3, it is determined whether or not the shutter button 28sh is half-depressed, and as long as a determined result is NO, the simple AE process is repeated in a step S5. Thereby, a brightness of the live view image is adjusted roughly.

When the determined result of the step S3 is updated from NO to YES, in a step S7, the strict AE process is executed, and in a step S9, the AF process is executed. A brightness of the live view image is strictly adjusted by the strict AE process, and a sharpness of the live view image is improved by the AF process.

In a step S11, it is determined whether or not the shutter button 28sh is fully depressed, and in a step S13, it is determined whether or not an operation of the shutter button 28sh is cancelled. When YES is determined in the step S13, the process directly returns to the step S3, and when YES is determined in the step S11, the process returns to the step S3 via processes in steps S15 to S21.

In the step S15, it is determined which of the normal mode and the HDR mode is an imaging mode at a current time point. When the imaging mode at the current time point is the normal mode, in the step S17, the still-image taking process is executed, and when the imaging mode at the current time point is the HDR mode, in the step S19, the HDR process is executed.

As a result of the still-image taking process in the step S17, one frame of image data representing a scene at a time point at which the shutter button 28sh is fully depressed is evacuated from the YUV image area 32b to the still-image area 32c. As a result of the HDR process in the step S19, three frames of image data respectively corresponding to three exposure amounts different from one another are taken into the still-image area 32c, and one frame of composite image data is created on the work area 32d. The created composite image data is returned to the still-image area 32c.

Upon completion of the process in the step S17 or S19, in the step S21, a corresponding command is applied to the memory I/F 40 in order to execute the recording process. The memory I/F 40 reads out the one frame of the image data stored in the still-image area 32c through the memory control circuit 30 so as to record the read-out image data on the recording medium 42 in a file format.

The HDR process in the step S19 is executed according to a subroutine shown in FIG. 11 to FIG. 13.

In a step S31, YUV-formatted image data (=image data of the first frame) that is based on raw image data outputted from the imager 16 after the shutter button 28sh being fully depressed is evacuated from the YUV image area 32b to the still-image area 32c. In a step S33, an exposure setting (=an aperture amount and/or an exposure time period) is changed so that an exposure amount of the imaging surface indicates a times an exposure amount equivalent to the optimal EV value. In a step S35, YUV-formatted image data (=image data of the second frame) that is based on raw image data outputted from the imager 16 after the process in the step S33 is evacuated from the YUV image area 32b to the still-image area 32c.

In a step S37, the exposure setting (=the aperture amount and/or the exposure time period) is changed so that the exposure amount of the imaging surface indicates 1/a times the exposure amount equivalent to the optimal EV value. In a step S39, YUV-formatted image data (=image data of the third frame) that is based on raw image data outputted from the imager 16 after the process in the step S37 is evacuated from the YUV image area 32b to the still-image area 32c. As a result, the three frames of the image data respectively corresponding to the three exposure amounts different from one another are secured in the still-image area 32c.

In a step S41, a positional deviation between an image represented by the image data of the first frame and an image represented by the image data of the second frame is detected as the offset OFST12, and in a step S43, a positional deviation between the image represented by the image data of the first frame and an image represented by the image data of the third frame is detected as the offset OFST13. In a step S45, the image data of the first frame to the third frame evacuated to the still-image area 32c are duplicated on the work area 32d, and the duplicated three frames of the image data are individually reduced. Thereby, reduced image data of the first frame to the third frame are acquired on the work area 32d.

In a step S47, the histogram of the reduced image data of the second frame is detected so as to calculate the shift amount SFT_S based on the detected histogram. The calculated shift amount SFT_S is equivalent to a coefficient for inhibiting a positional deviation of a histogram between the reduced image data of the first frame and the reduced image data of the second frame.

In a step S49, the composing process is performed on the reduced image data of the first frame and the reduced image data of the second frame. Firstly, a luminance of the reduced image data of the second frame is adjusted so that the histogram of the reduced image data of the second frame is shifted to the low luminance side by the shift amount SFT_S calculated in the step S47. Subsequently, with reference to the offset OFST12 calculated in the step S41, the reduced image data having the adjusted luminance is composed with the reduced image data of the first frame. Thereby, the intermediate-composite reduced image data in which blocked-up shadows are improved is acquired on the work area 32d.

In a step S51, the histogram of the reduced image data of the third frame is detected so as to calculate the gain GN_S based on the detected histogram. The calculated gain GN_S is equivalent to a coefficient for extending the histogram of the reduced image data of the third frame to the high luminance side.

In a step S53, the composing process is performed on the intermediate composite reduced image data created in the step S49 and the reduced image data of the third frame. Firstly, a luminance of the reduced image data of the third frame is amplified according to the gain GN_S calculated in the step S51. Subsequently, with reference to the offset OFST13 calculated in the step S43, reduced image data having the amplified luminance is composed with the intermediate composite reduced image data. Thereby, final composite reduced image data in which both of the blocked-up shadows and blown-out highlights are improved is acquired on the work area 32d.

In a step S55, the histogram of the final composite reduced image data created in the step S53 is detected so as to calculate the shift amount SFT_L based on the detected histogram. The calculated shift amount SFT_L is equivalent to a coefficient for shifting the histogram of the final composite reduced image data to the low luminance side.

In a step S57, the gain GN_L is calculated based on the histogram of the final composite reduced image data detected in the step S53. The calculated gain GN_L is equivalent to a coefficient for extending the histogram of the final composite reduced image data to the high luminance side.

In a step S59, the shift amount SFT_L calculated in the step S55 is added to the shift amount SFT_S calculated in the step S47 so as to obtain the corrected shift amount SFT_C. In a step S61, the gain GN_L calculated in the step S57 is multiplied by the gain GN_S calculated in the step S51 so as to obtain the corrected gain GN_C.

In a step S63, the image data of the first frame to the second frame evacuated to the still-image area 32c are duplicated on the work area 32d, and the composing process is executed on the duplicated two frames of the image data. Firstly, a luminance of the image data of the second frame is adjusted so that the histogram of the image data of the second frame is shifted to the low luminance side by the corrected shift amount SFT_C calculated in the step S59. Subsequently, with reference to the offset OFST12 calculated in the step S41, the image data having the adjusted luminance is composed with the image data of the first frame. Thereby, intermediate-composite image data in which the blocked-up shadows are further improved is acquired on the work area 32d.

In a step S65, the image data of the third frame evacuated to the still-image area 32c is duplicated on the work area 32d, and the composing process is executed on the intermediate-composite image data created in the step S63 and the duplicated image data of the third frame. Firstly, a luminance of the image data of the third frame is amplified according to the gain GN_C calculated in the step S61. Subsequently, with reference to the offset OFST13 calculated in the step S43, image data having the amplified luminance is composed with the intermediate composite image data. Thereby, final composite image data in which both of the blocked-up shadows and blown-out highlights are further improved is acquired on the work area 32d.

In a step S67, the final composite image data thus created is duplicated from the work area 32d to the still-image area 32c. Upon completion of duplicating, the process returns to a routine in an upper hierarchy.

As can be seen from the above-described explanation, when the shutter button 28sh is fully depressed in a state where the HDR mode is selected, the CPU 26 acquires the three frames of the image data, respectively corresponding to an optimal exposure amount, an excessive exposure amount and an insufficient exposure amount, and each of which represents a common scene (S31, S35 and S39). Moreover, the CPU 26 calculates the shift amount SFT_S and the gain GN_S both equivalent to the composite coefficient, with reference to each of the histograms of the image data of the second frame and the image data of the third frame out of the acquired three frames of the image data (S47 and S51).

The three frames of the reduced image data corresponding to the three frames of the image data acquired corresponding to the three exposure amounts are composed with reference to the calculated shift amount SFT_S and the gain GN_S (S45, S49 and S53). The shift amount SFT_S and the gain GN_S are corrected based on the shift amount SFT_L and the gain FN_L calculated with reference to the histogram of the composite reduced image data (S55 to S61), and thereby, the corrected shift amount SFT_C and the corrected gain GN_C are obtained. The three frames of the image data acquired corresponding to the three exposure amounts are composed with reference to the corrected shift amount SFT_C and the corrected gain GN_C thus obtained (S63 to S65), and thereby, the composite image data is created.

Thus, the shift amount and the gain are calculated based on the acquired three frames of the image data, and is corrected based on the composite reduced image data that is based on the three frames of the image data. The composing process for the acquired three frames of the image data is executed again with reference to the corrected shift amount and the gain. Thereby, the image composing performance is improved.

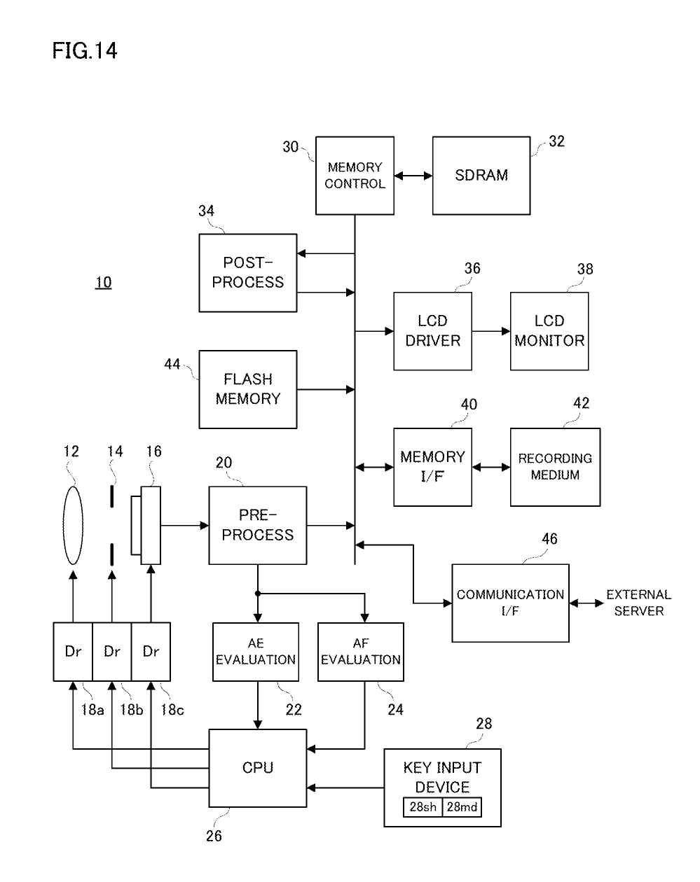

It is noted that, in this embodiment, the control programs equivalent to the multi task operating system and the plurality of tasks executed thereby are previously stored in the flash memory 44. However, a communication I/F 46 may be arranged in the digital camera 10 as shown in FIG. 14 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks in a manner described above. However, these tasks may be further divided into a plurality of small tasks, and furthermore, a part of the divided plurality of small tasks may be integrated into another task. Moreover, when a transferring tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
an acquirer which acquires a plurality of images, respectively corresponding to a plurality of exposure amounts different from one another, and each of which represents a common scene;
a calculator which calculates a composite coefficient with reference to at least a part of luminance characteristics of the plurality of images acquired by said acquirer;
a first composer which composes the plurality of images acquired by said acquirer with reference to the composite coefficient calculated by said calculator;
a corrector which corrects a value of the composite coefficient calculated by said calculator with reference to a luminance characteristic of a composed image created by said first composer, and
a second composer which composes the plurality of images acquired by said acquirer with reference to a composite coefficient having the value corrected by said corrector.

2. An image processing apparatus according to claim 1, wherein said first composer includes a reducer which creates a plurality of reduced images by reducing a resolution of each of the plurality of images, and a composing processor which performs a composing process on the plurality of reduced images created by said reducer.

3. An image processing apparatus according to claim 1, wherein the plurality of images acquired by said acquirer includes a first image corresponding to an appropriate exposure amount, a second image corresponding to an excessive exposure amount and a third image corresponding to an insufficient exposure amount, and said calculator includes a first shift amount calculator which calculates a first shift amount shifting a luminance distribution of the second image to a low luminance side, as a part of the composite coefficient, and a first gain calculator which calculates a first gain extending a luminance distribution of the third image to a high luminance side, as another part of the composite coefficient.

4. An image processing apparatus according to claim 3, wherein said corrector includes a second shift amount calculator which calculates a second shift amount shifting a luminance distribution of the composed image to the low luminance side, and a second gain calculator which calculates a second gain extending the luminance distribution of the composed image to the high luminance side.

5. An image processing apparatus according to claim 4, wherein said corrector further includes a third shift amount calculator which calculates a third shift amount obtained by adding the second shift amount calculated by said second shift amount calculator to the first shift amount calculated by said first shift amount calculator, as a part of the composite coefficient, and a third gain calculator which calculates a third gain obtained by multiplying the second gain calculated by said second gain calculator by the first gain calculated by said first gain calculator, as another part of the composite coefficient.

6. An image processing apparatus according to claim 1, further comprising an imager which outputs an image representing a scene captured on an imaging surface, wherein the image acquired by said acquirer is equivalent to the image outputted from said imager.

7. An image composing program recorded on a non-transitory recording medium in order to control an image processing apparatus, the program causing a processor of the image processing apparatus to perform the steps, comprising:
an acquiring step of acquiring a plurality of images, respectively corresponding to a plurality of exposure amounts different from one another, and each of which represents a common scene;
a calculating step of calculating a composite coefficient with reference to at least a part of luminance characteristics of the plurality of images acquired by said acquiring step;
a first composing step of composing the plurality of images acquired by said acquiring step with reference to the composite coefficient calculated by said calculating step;
a correcting step of correcting a value of the composite coefficient calculated by said calculating step with reference to a luminance characteristic of a composed image created by said first composing step; and
a second composing step of composing the plurality of images acquired by said acquiring step with reference to a composite coefficient having the value corrected by said correcting step.

8. An image composing method executed by an image processing apparatus, comprising:
an acquiring step of acquiring a plurality of images, respectively corresponding to a plurality of exposure amounts different from one another, and each of which represents a common scene;
a calculating step of calculating a composite coefficient with reference to at least a part of luminance characteristics of the plurality of images acquired by said acquiring step;
a first composing step of composing the plurality of images acquired by said acquiring step with reference to the composite coefficient calculated by said calculating step;
a correcting step of correcting a value of the composite coefficient calculated by said calculating step with reference to a luminance characteristic of a composed image created by said first composing step; and
a second composing step of composing the plurality of images acquired by said acquiring step with reference to a composite coefficient having the value corrected by said correcting step.
